(19) United States
(12) Patent Application Publication
(10) Pub. No.: US 2009/0295305 A1
(43) Pub. Date: Dec. 3, 2009

(54) LED DRIVER CIRCUIT

(75) Inventors: NIAN TZU WU, HSINCHU (TW); DONG MIN CHEN, HSINCHU (TW); SHENG SHOU WANG, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED ANALOG TECHNOLOGY, INC., Hsinchu (TW)

(21) Appl. No.: 12/173,958

(22) Filed: Jul. 16, 2008

(30) Foreign Application Priority Data
Jun. 2, 2008 (TW) 097120427

(51) Int. Cl. H05B 41/36

(52) U.S. Cl. 315/291

(57) ABSTRACT

An LED driver circuit comprises a buck-boost converter circuit and a resistor. The cathode terminal of the LED is connected to the output terminal of the buck-boost converter circuit. The anode terminal of the LED is connected to a reference voltage. The resistor connects the anode terminal of the LED to a power input.

### BACKGROUND OF THE INVENTION

1. Field of the Invention

The present invention relates to a driver circuit, and more particularly, to a light-emitting diode (LED) driver circuit.

2. Description of the Related Art

In the past, LEDs have often been used in electronic devices such as indicator lights or displaying plates. With the emergence of white LEDs, however, LEDs are further applied to illumination devices and are expected to be the main illumination devices in the near future because they consume less power, have a longer lifetime, and are less likely to be damaged compared to conventional light sources. For instance, most back light modules in current mobile electronic devices, such as digital still cameras, digital photo frames or global positioning systems, are implemented by LEDs for the requirement of low power consumption.

Because the electrical output of typical integrated circuits is too low to provide sufficient current for LEDs, power supply circuits combined with driver circuits are often used to drive and turn on LEDs. FIG. 1 shows a conventional LED driver circuit. The LED driver circuit 100 comprises a boost converter circuit 110, a resistor 120 and an LED 130. The boost converter circuit 110 comprises a first capacitor 111, an inductor 112, a switch 113, a diode 114 and a second capacitor 115. The anode of the LED 130 is connected to the output terminal of the boost converter circuit 110. The cathode of the LED 130 is connected to a reference voltage and is grounded via the resistor 120. The input voltage of the boost converter circuit 110 comes from an output power voltage of a power supply circuit. The input control terminal of the boost converter circuit 110 is connected to an output control signal of the power supply circuit. The power voltage is between 3.4 and 5 volts. The LED 130 is a white LED, and the relationship between the voltage across and the current flowing through the LED 130 is shown in FIG. 2. As shown in FIG. 2, the ideal voltage across the LED 130 is 3.2 volts, which combines with the reference voltage of 1.25 volts to make the output voltage of the boost converter circuit 110 4.45 volts. However, it violates the principle of the boost converter circuit 100 for the output voltage thereof (4.45 volts) lying in the input voltage range thereof (3.4 to 5 volts). Therefore, the LED 130 cannot be operated in its ideal working range and is unable to illuminate normally. Moreover, when the switch 113 is non-activated, the voltage across the LED 130, which is the input voltage minus the voltage across the inductor 112 and the diode 114, is still large enough to turn on the LED 130. In consequence, the LED 130 still emits a small amount of light even when the boost converter circuit 110 is not in work state, which is an undesirable situation.

To solve the problem of the output voltage of the boost converter circuit 110 lying within the input voltage range of the boost converter circuit 110, it is typical to connect multiple LEDs 130 in series to raise the output voltage of the boost converter circuit 110. However, the solution is not suitable for single LED systems. On the other hand, a bucking circuit can be connected to the input of the boost converter circuit 110 to lower the input voltage thereof. However, this significantly increases hardware cost.

FIG. 3 shows another conventional LED driver circuit. The LED driver circuit 300 comprises a buck converter circuit 310, a resistor 320 and an LED 330. The buck converter circuit 310 comprises a first capacitor 311, an inductor 312, a switch 313, a diode 314 and a second capacitor 315. The anode of the LED 330 is connected to the output terminal of the buck converter circuit 310. The cathode of the LED 330 is connected to a reference voltage and is grounded via the resistor 320. The input voltage of the buck converter circuit 310 comes from an output power voltage of a power supply circuit. The input control terminal of the buck converter circuit 310 is connected to an output control signal of the power supply circuit. The power voltage is between 3.4 and 5 volts. The LED 330 is a white LED, and the ideal voltage across the LED 330 is 3.2 volts, which combines with the reference voltage of 1.25 volts to make the total output voltage of the boost converter circuit 110 4.45 volts. Like the boost converter circuit 110 in FIG. 1, it violates the principle of the buck converter circuit 310 for the output voltage thereof (4.45 volts) falling within the input voltage range thereof (3.4 to 5 volts). Therefore, the LED 330 cannot be operated in its ideal working range and is unable to illuminate normally. To solve the problem of the output voltage of the buck converter circuit 310 falling within the input voltage range of the buck converter circuit 310, a boosting circuit can be connected to the input of the buck converter circuit 310 to raise the input voltage thereof. Likewise, this will significantly increase hardware cost.

In view of the disadvantages of the prior art, there is a need to design an LED driver circuit that has no range constraint for its input and output voltage, does not cause the driven LED to illuminate when turned off, and can be applied to a single LED system.

### SUMMARY OF THE INVENTION

The LED driver circuit according to one embodiment of the present invention comprises a first capacitor, an inductor, a switch, a diode, a second capacitor and a resistor. The first capacitor connects an input voltage to ground. One end of the inductor is grounded. The switch is controlled by a control signal and connects the input voltage to the other end of the inductor. The cathode of the diode is connected to the common node of the inductor and the switch. The second capacitor connects the anode of the diode to ground. The cathode of the LED is connected to the anode of the diode, and the anode of the LED is connected to a reference voltage. The resistor connects the anode of the LED to a supply voltage.

The LED driver circuit according to another embodiment of the present invention comprises a buck-boost converter circuit and a resistor. The cathode of the LED is connected to the output terminal of the buck-boost converter circuit, and the anode of the LED is connected to a reference voltage. The resistor connects the anode of the LED to a supply voltage.

### BRIEF DESCRIPTION OF THE DRAWINGS

The objectives and advantages of the present invention will become apparent upon reading the following description and upon referring to the accompanying drawings among which:

FIG. 1 shows a conventional LED driver circuit;

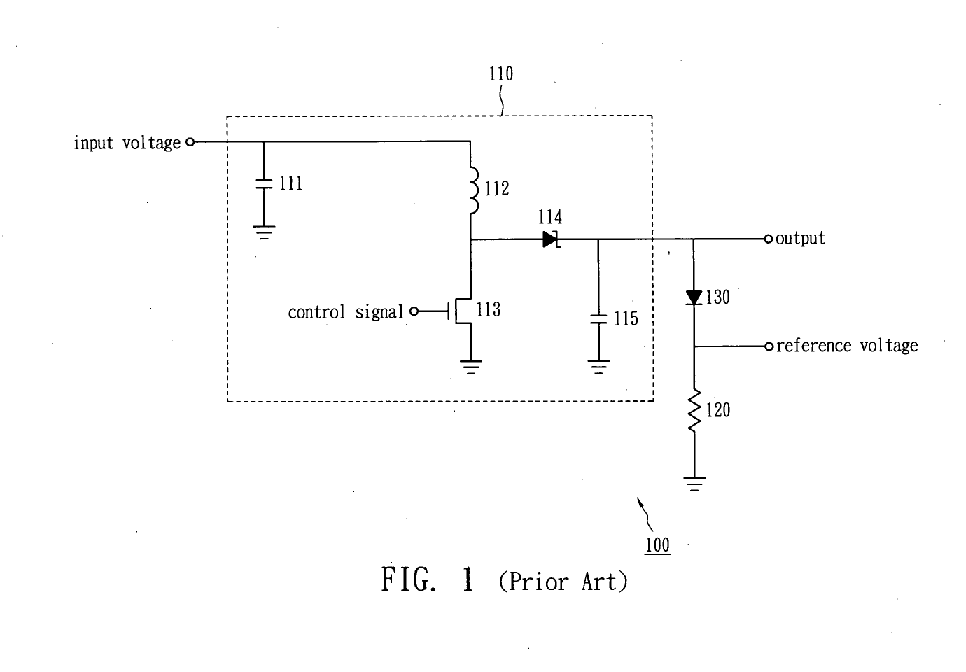

FIG. 2 shows the relationship between the voltage across and the current flowing through an LED;

FIG. 3 shows another conventional LED driver circuit; and

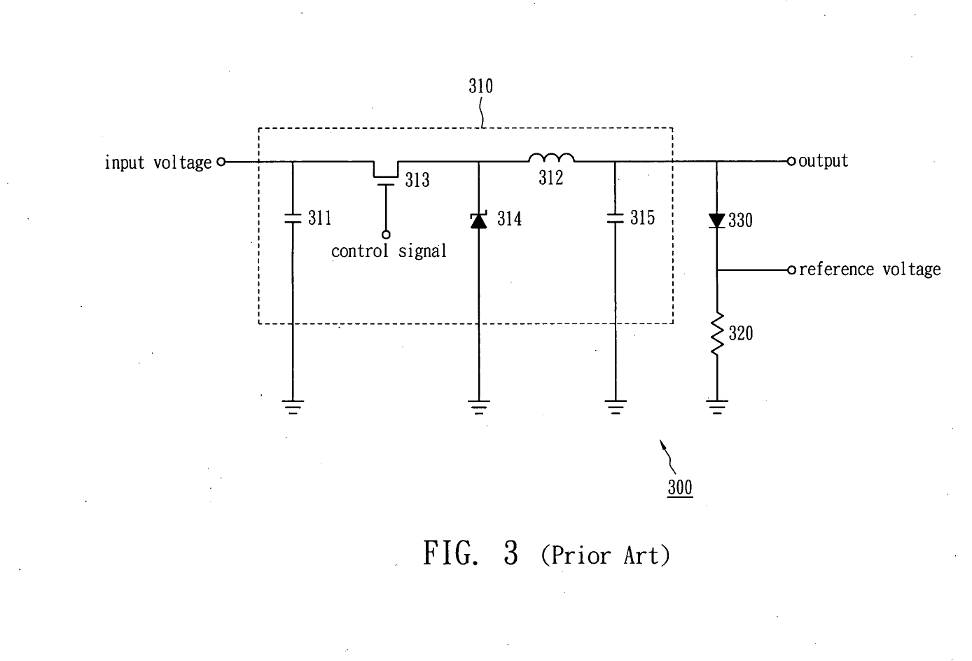

FIG. 4 shows a block diagram of the LED driver circuit according to one embodiment of the present invention.

### DETAILED DESCRIPTION OF THE INVENTION

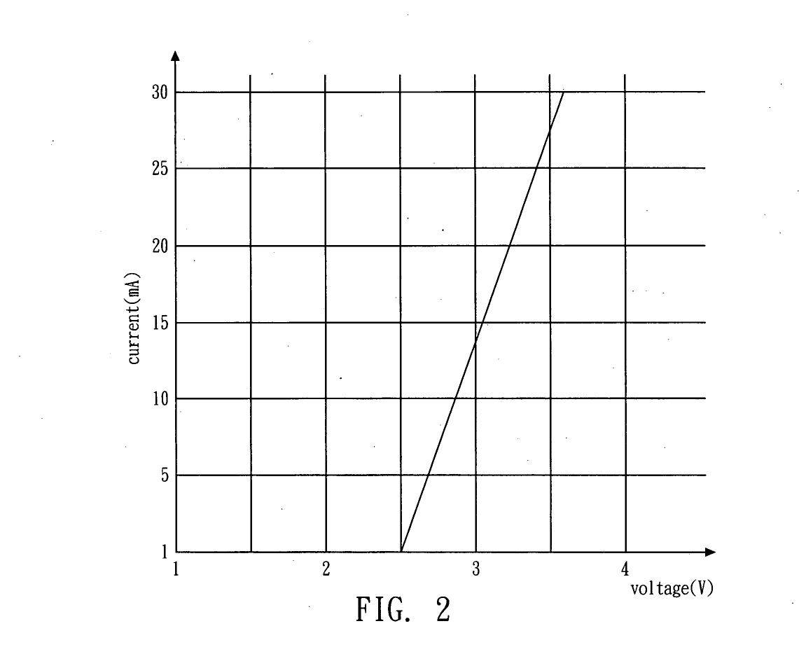

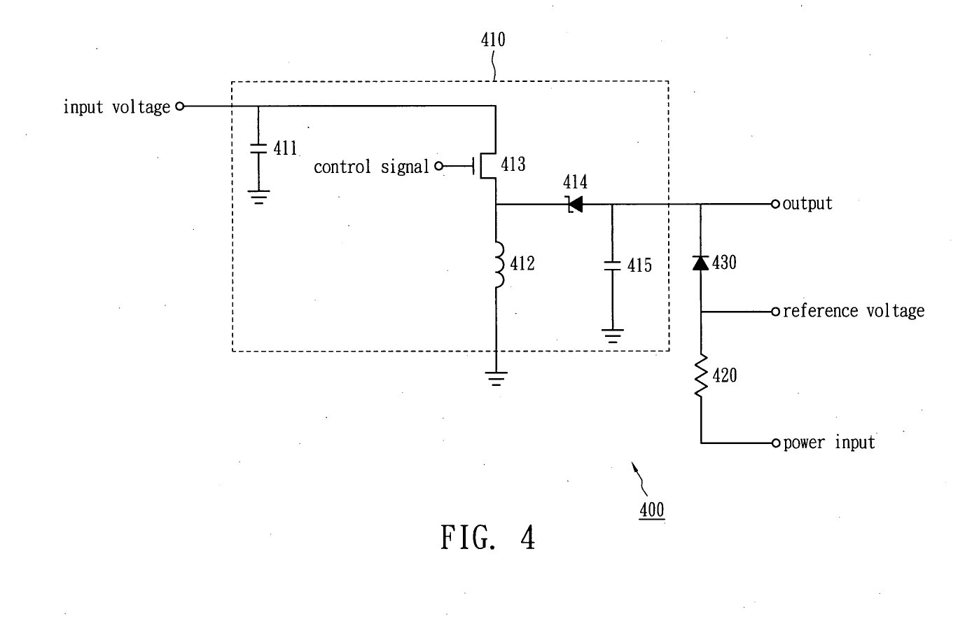

FIG. 4 shows a block diagram of the LED driver circuit according to one embodiment of the present invention. The LED driver circuit 400 comprises a buck-boost converter circuit 410, a resistor 420 and an LED 430. The buck-boost converter circuit 410 comprises a first capacitor 411, an inductor 412, a switch 413, a diode 414 and a second capacitor 415. One end of the first capacitor 411 is connected to ground, and the other end of first capacitor 411 is connected to an input voltage, which is an output power voltage of a power supply circuit. The switch 413 connects the non-grounded end of the inductor 412 to the input voltage, and is controlled by an output control signal of the power supply circuit. The cathode of the diode 414, a Schottky diode, is connected to the common node of the inductor 412 and the switch 413, and the anode of the diode 414 is connected to the non-grounded end of the second capacitor 415. The cathode of the LED 430 is connected to the anode of the diode 414, and the anode of the LED 430 is connected to a reference voltage and to one end of the resistor 420. The other end of the resistor 420 is connected to a power input, which is another output power voltage of the power supply circuit (between 1.2 and 1.5 volts) and provides current to the LED 430. In some applications, the LED 430 could be a white LED, and the relationship between the voltage across and the current flowing through the LED 430 is shown in FIG. 2. In the present embodiment, the input voltage is between 3.4 and 5 volts, and the reference voltage is 0 volts, wherein there is no current flowing from or to the reference voltage.

The output voltage of the buck-boost converter circuit 410 is a negative voltage. The voltage at the anode of the diode 414 is therefore lower than 0 volts. When the switch 413 is activated, the voltage at the non-grounded end of the inductor 412 is the input voltage, and the diode 414 is non-activated. The input voltage charges the inductor 412 during this time, and there is no closed current loop for the LED 430, so the LED 430 is not illuminating. When the switch 413 is non-activated, on the other hand, the voltage at the non-grounded end of the inductor 412 is lowered to the output voltage of the buck-boost converter circuit 410, and thus the diode 414 is activated. A current from the power input flows through resistor 420, the LED 430, the diode 414 and the inductor 412 to ground, and the LED 430 is illuminating. Because the reference voltage is 0 volts, and there is no current flowing from or to the reference voltage, the amount of current flowing through the LED 430 is controlled by adjusting the resistance value of the resistor 420. Preferably, the current flowing through the LED 430 is between 20 and 25 milliampere, and the voltage across the LED 430 is between 3.2 and 3.4 volts.

Because the switching frequency of the switch 413 is very high, it is hard to notice that the LED 430 is not illuminating when it is non-activated. In addition, because the voltage across the LED 430, i.e., the output voltage of the buck-boost converter circuit 410 or the voltage across the second capacitor 415, is controlled by the resistor 420, the LED driver circuit 400 has no operative constraint for its input and output voltages. On the other hand, when the LED driver circuit 400 is not operative, the switch 413 is non-activated and there is no charge stored on the inductor 412 and the second capacitor 415. Therefore, as long as the power input is not large enough to activate the LED 430, the LED 430 will not illuminate.

In conclusion, the LED driver circuit 400 of the above-mentioned embodiment has no operative constraint for its input and output voltage, so there is no need for it to be connected to a bucking circuit or boosting circuit, and it can easily be applied to a single LED system. In addition, when the LED driver circuit 400 is not in operation, the LED 430 will not illuminate. On the other hand, a typical power supply circuit comprises multiple channel outputs corresponding to different voltage values, including negative output voltage. For some applications, such as digital still camera by CMOS process or digital photo frame, the negative output voltage provided by a power supply circuit is often not utilized. Therefore, the LED driver circuit 400 can be easily implemented by such a power supply circuit without increasing extra hardware cost.

The above-described embodiments of the present invention are intended to be illustrative only. Those skilled in the art may devise numerous alternative embodiments without departing from the scope of the following claims.

What is claimed is:

1. A circuit for driving a light-emitting diode (LED), comprising:
an inductor;
a switch connecting an input voltage to the inductor, wherein the switch is controlled by a control signal;
a diode with its cathode connected to a common node of the inductor and the switch, wherein the anode of the diode is connected to the cathode of the LED; and
a resistor connecting the anode of the LED to a power input.

2. The circuit of claim 1, wherein the LED is a white LED.

3. The circuit of claim 1, wherein the diode is a Schottky diode.

4. The circuit of claim 1, wherein one end of the LED is grounded.

5. The circuit of claim 1, wherein one end of the LED is connected to a reference voltage without any current flowing therefrom.

6. The circuit of claim 1, wherein the voltage of the power input is between 1.2 and 1.5 volts.

7. The circuit of claim 1, wherein the current flowing through the LED is between 20 and 25 milliamperes when the LED is turned on.

8. The circuit of claim 1, wherein the voltage across the LED is between 3.2 and 3.4 volts when the LED is turned on.

9. The circuit of claim 1, further comprising a first capacitor connecting the input voltage to ground.

10. The circuit of claim 1, further comprising a second capacitor connecting the anode of the diode to ground.

11. A circuit for driving a light-emitting diode (LED), comprising:
a buck-boost converter circuit, wherein the output terminal of the buck-boost converter circuit is connected to the cathode of the LED; and
a resistor connecting the anode of the LED to a power input.

12. The circuit of claim 11, wherein the LED is a white LED.

13. The circuit of claim 11, wherein the anode of the LED is grounded.

14. The circuit of claim 11, wherein one end of the LED is connected to a reference voltage without any current flowing therefrom.

15. The circuit of claim 11, wherein the voltage of the power input is between 1.2 and 1.5 volts.

16. The circuit of claim 11, wherein the current flowing through the LED is between 20 and 25 milliamperes when the LED is turned on.

17. The circuit of claim 11, wherein the voltage across the LED is between 3.2 and 3.4 volts when the LED is turned on.
